(19) United States
(12) Patent Application Publication
(10) Pub. No.: US 2013/0089637 A1
(43) Pub. Date: Apr. 11, 2013

(54) FEEDING DEVICE

(71) Applicants: Karl-Josef Huber-Haag, Pully (CH); Isabelle Bureau-Franz, Paris (FR)

(72) Inventors: Karl-Josef Huber-Haag, Pully (CH); Isabelle Bureau-Franz, Paris (FR)

(73) Assignee: NESTEC S.A., Vevey (CH)

(21) Appl. No.: 13/703,994

(22) PCT Filed: May 27, 2011
(86) PCT No.: PCT/EP2011/058745

§ 371 Date: Dec. 13, 2012

(30) Foreign Application Priority Data
Jun. 14, 2010 (EP) 10165809.4

(51) Int. Cl. A61J 9/00; A61J 11/00; B65B 1/04

(52) U.S. Cl. CPC A61J 9/00; B65B 1/04; A61J 11/00
USPC 426/2; 215/11.1; 215/11.4; 53/467

(57) ABSTRACT

The invention relates to a feeding device (1, 1′, 1″) having a hollow form, the feeding device (1, 1′, 1″) comprising: an inlet portion (2, 2′, 2″) having an inlet (4, 4′) for entering nutrition (13), and a suction portion (3, 3′, 3″) for sucking the nutrition (13) through the inlet (4, 4′) into the feeding device (1, 1′, 1″), wherein the suction portion (3, 3′, 3″) comprises at least one opening (5, 5′, 5″) for dispensing the sucked nutrition (13), wherein the inner surface (6, 6′, 6″) of the feeding device (1, 1′, 1″) confines a flow path (P, P′, P″) for the nutrition (13), and wherein the feeding device (1, 1′, 1″) is at least partially deformable. The feeding device is characterized in that a nutritional additive (7, 7′, 7″) is adhered to the flow path confining inner surface (6, 6′, 6″) of the feeding device (1, 1′, 1″) such that the nutritional additive (7, 7′, 7″) is mechanically segregated from the inner surface (6, 6′, 6″) when the feeding device (1, 1′, 1″) is deformed.

The present invention relates to a feeding device, particularly a hollow feeding device comprising an inlet portion and a suction portion having an outlet, to a feeding apparatus comprising a container and said feeding device as well as a method for mixing a nutrition and a nutritional additive in said feeding device, and a method for enclosing a non-homogeneous solution of a nutritional additive in a viscous or liquid carrier within said feeding device.

Straws or nipples, a part of which coming into contact with the user's mouth being impregnated or absorbed with odors or flavors, are known in the prior art as, for instance, in U.S. Pat. No. 5,932,262.

WO 97/37636 shows an antibody being placed in the form of a liquid, emulsion or cream on or in a nipple. On the nipple there are paths, incisions or semi-permeable surfaces through which said antibody can seep into the mouth when the nipple is sucked. On the one hand, due to this arrangement, antibodies or the like may at least partially stick to the delivery system comprising the respective paths, incisions or semi-permeable surfaces such that not all the additives can reach the user's mouth. On the other hand, since a fluid additive (liquid, emulsion, cream) is needed to be used, a loss of said additive via the mentioned paths, incisions or semi-permeable surface may occur before use. Hence, it is difficult to determine the required amount of the nutritional additive.

In addition, the amount of the additives (like antibodies in the case of WO 97/37636) reaching the user's mouth is dependent on the suction power of the user. In the first months or years of their life, infant's suction power strongly increases and, in addition, all babies of the same age also have different suction powers. Therefore, the dosage of the additive cannot be certainly determined and, since in most cases not all the additive will be removed from the nipple, there will be a loss of additive, while in turn a bulk delivery of the additive still occurs.

The present invention has been achieved in view of the above-mentioned drawbacks, and an object thereof is to improve the passage of a nutritional additive deposit from the nipple to the mouth or body of a user in a safe and efficient way.

The object is to be accomplished by means of the independent claims. The dependent claims advantageously study further the central idea of the invention.

According to an aspect of the invention, there is provided a feeding device having a hollow form, the feeding device comprising: an inlet portion having an inlet for entering nutrition, and a suction portion for sucking the nutrition through the inlet into the feeding device, wherein the suction portion comprises at least one opening for dispensing the sucked nutrition, and wherein the feeding device is at least partially deformable. The inner surface confines a flow path for the nutrition. The feeding device is characterized in that a nutritional additive is adhered to the flow path confining inner surface of the feeding device such that the nutritional additive is mechanically segregated from the inner surface when the feeding device is deformed.

By means of the above described feature, the nutritional additive is purposely located by the manufacturer/producer at a place which is influenced by the suction of the user and through which the nutrition passes. Hence, a mechanically segregation of the nutritional additive during a suction process can be securely accomplished by the suction of the user, which leads to a deformation of the feeding device by means of which the nutritional additive falls off of the inner surface, further supported by interaction with the nutrition passing through the feeding device and thus also mechanically segregating and sweeping along the nutritional additive. Hence, the supply of the nutritional additive, particularly the amount of which, is not (only) dependent on the suction power of the user since there is a fine balance between the adhesion of the nutritional additive to the inner surface of the feeding device and the ability to be released upon mechanical movement by sucking, the interaction with the nutrition and/or the temperature, for example. The nutritional additive thus completely falls off of the wall and/or is swept along when the feeding device is sucked and nutrition is thus delivered through the feeding device to the user's mouth or the like. The dosage of the additive can be exactly determined, e.g. to a controlled monodose, thus allowing to precisely insure a safe and efficient dosage of the nutritional additive in comparison with a bulk delivery of additives.

Preferably, the nutrition is a liquid or viscous nutrition. Hence, a sufficiently high amount of a liquid can be provided to wash-out and dilute the deposit of the nutritional additive, particularly in comparison to a dry pacifier.

Preferably, the inner surface of the feeding device is treated to enable adhesion of the nutritional additive. Thereby, the nutritional additive can be easier adhered to the inner surface.

Preferably, the nutritional additive is mixed with a substance for promoting the adhesion of the mix to the inner surface of the feeding device and/or enhancing its stability. The substance can be a matrix, preferably an oil (e.g. containing MCT), an emulsion, a gel or wax. The substance, e.g. an oil or wax matrix, crystallizes at a temperature above room temperature (e.g. 40 degrees Celsius) and is thus solid at room temperature. Hence, the nutritional additive can be easily applied to the inner surface of the feeding device with a fluid matrix as a film cover which, after being applied thereto, cools down and gets solid, thus immobilizing the nutritional additive in the matrix. The nutritional additive can thus be securely adhered to the inner surface of the feeding device. Moreover, by suction of the baby, the shape of the feeding device is modified and due to this, the matrix-and-nutritional-additive film breaks and falls off the inner surface and subsequently falls into the nutrition passing through the feeding device. Since the inner surface confines the flow path of the nutrition, a secure release of the nutritional additive can be accomplished.

Moreover, in a case in which a warm nutrition is fed, the matrix will solubilize by means of the passing nutrition having a temperature above the crystallizing temperature, and the nutritional additive can thus be easily displaced by the nutrition due to its temperature and mechanical segregation.

In addition or alternative to the temperature, the releaseability of the matrix from the surface of the feeding device can also be attained or enhanced by the pH and/or the salinity of the nutrition. In other words, the segregation of the nutritional additive can be enhanced by either a dissolution of the additive and/or of the protective matrix (e.g. oil matrix or wax matrix), or a specific interaction in particular conditions such as pH of the nutritional composition enhancing segregation by acting on the protective matrix, or mechanical shaking of a container or bottle containing said nutrition and onto which the feeding device is mounted, or a combination thereof.

Hence, the deposition properties of the nutritional additive can be easily determined and adjusted by varying the balance between immobilization of the nutritional additive in the matrix, the stickiness of said matrix to the walls of the feeding device, and the ability of the matrix to be displaced by the nutrition and/or by the mechanical effect of the sucking.

Preferably, the nutritional additive is at least adhered to the flow path confining inner surface of the suction portion. Hence, the nutritional additive is located in the flow path of the nutrition and also at a place inside the feeding device that insures a complete removal, e.g. wash-out, due to its closeness to the tip of the feeding device, i.e. the outlet, where a lot of nutrition passes by.

Preferably, at least the suction portion of the feeding device is deformable. Hence, the nutritional additive, when being placed in said deformable portion of the feeding device, i.e. the suction portion, is securely segregated or released from the inner surface of the feeding device since the segregation is promoted by the respective deformation of the feeding device caused by the suction which in any case occurs when being used.

Preferably, the opening in the suction portion is a valve means being designed such that it only opens under suction. Thereby, a loss of nutrition and nutritional additive can be avoided when the feeding device is not in use, i.e. sucked.

Preferably, the feeding device comprises at least a further opening as an air inlet when the feeding device is sucked. By means of said feature, the flow of air through said hole can be enabled during suction when the feeding device is adapted to a non-flexible container, e.g. a glass container, or the like. Even when using a flexible container, the air-flow through said opening may facilitate the suction action when sucking the feeding device.

Preferably, the feeding device has an anatomical shape, preferably at least two diameters, wherein the inlet portion has a bigger diameter than the suction portion. Hence, the small diameter of the suction portion enables the lips of a user to grab the suction portion or nipple or teat, and the larger diameter of the inlet portion fits a diameter of a container (e.g. a bottle). The transition portion from the small diameter to the larger diameter can act as a stopper for the user's mouth.

Preferably, the feeding device is made of a flexible material, preferably a flexible polymeric material, more preferably silicon. By means of said feature, the feeding device can be easily and economically produced while at the same time leads to a sufficient flexibility or formability such that the matrix-and-nutritional-additive film can be easily broken when the user sucks at the feeding device, thus promoting the removal of the nutritional additive during the suction action.

According to another aspect of the invention, there is provided a feeding apparatus comprising: a container having an outlet, and a feeding device according any of the preceding claims, the feeding device being mounted on the outlet of the container with its inlet portion. Hence, the feeding device can be used in a commonly known apparatus as, for example, a baby bottle which can also be used for feeding animals or the like.

Preferably, the feeding apparatus further comprises a fixing means for removably linking the feeding device to the container. The fixing means can be an adaptation ring with a closure mechanism or a screw thread. Hence, the feeding device can be easily applied to and removed from the apparatus.

Further features, advantages and objects of the present invention would come apparent for the skilled person when reading the following detailed description of embodiments of the present invention, when taking in conjunction with the figures of the enclosed drawings.

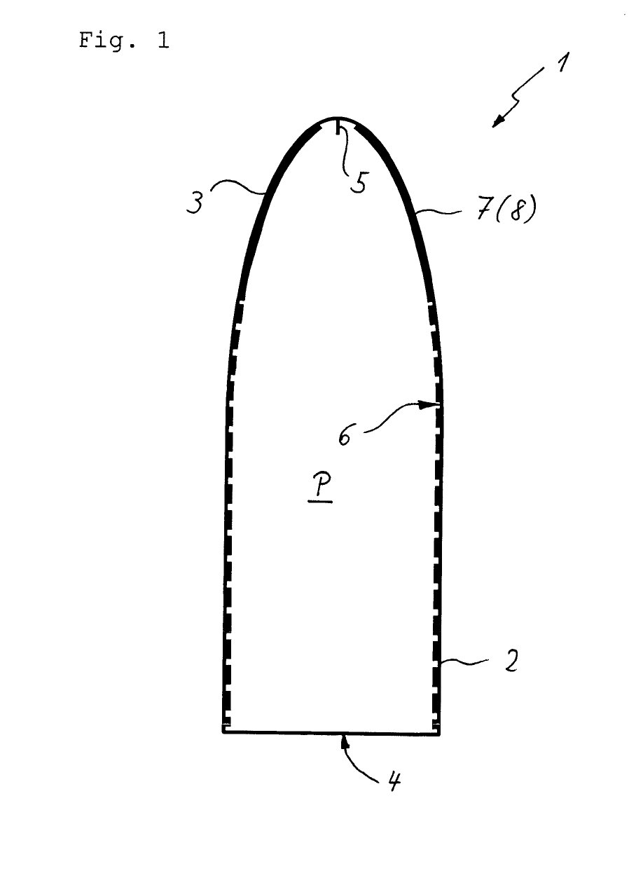

FIG. 1 shows a first embodiment of a feeding device.

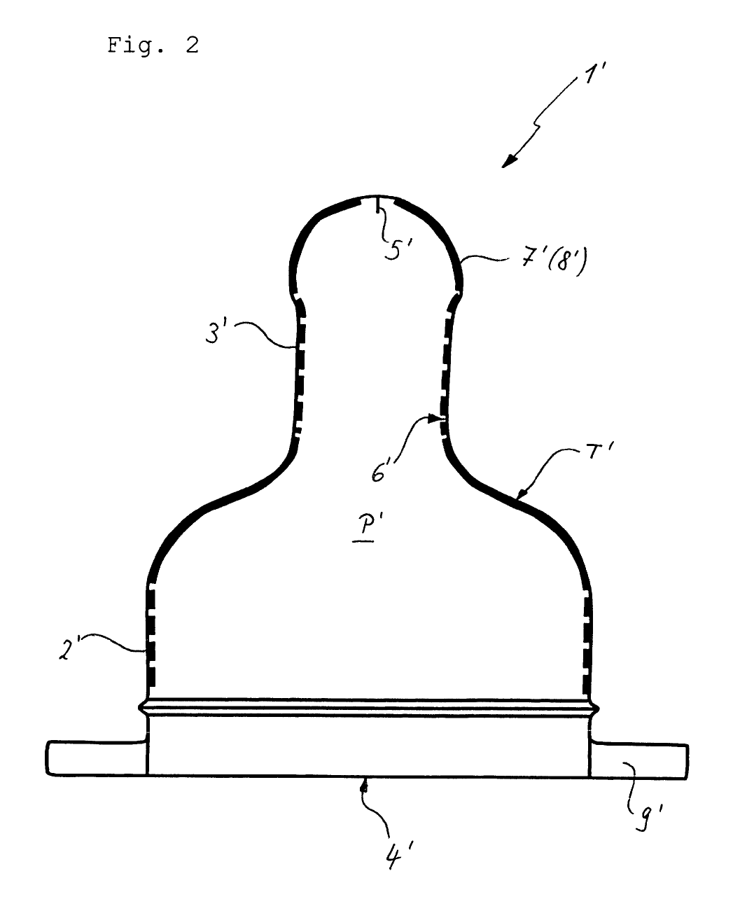

FIG. 2 shows a second embodiment of a feeding device.

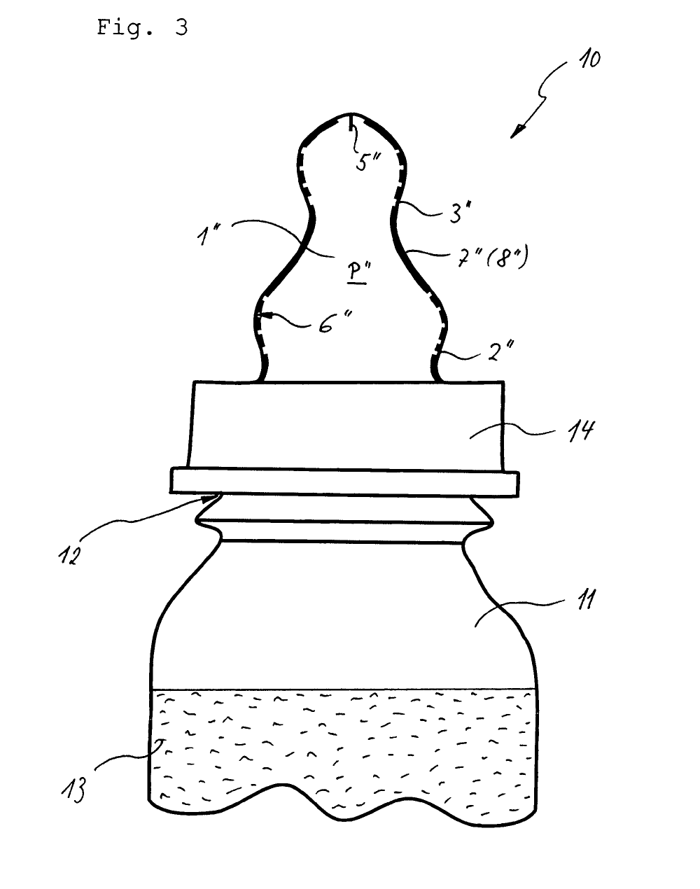

FIG. 3 shows a feeding apparatus comprising a third embodiment of a feeding device.

FIG. 1 shows a first embodiment of a feeding device 1 according the invention. The feeding device 1 is hollow, thus defining an inner surface 6. The inner surface 6 defines or confines a flow path P for nutrition, such that nutrition can pass through the feeding device 1. The feeding device 1 comprises an inlet portion 2 and a suction portion 3. The feeding device 1 is at least partially deformable, preferably at least the suction portion 3 is deformable, and can be made of any known material for feeding devices, preferably a flexible material, more preferably a flexible polymeric material, further preferably silicon.

The inlet portion 2 comprises an inlet 4 for entering nutrition when the feeding device 1 is sucked. Therefore, the feeding device 1 can be used as a straw thus sucking the nutrition via the inlet 4 into the feeding device 1 or, preferably, as a nipple, e.g. for a baby bottle, as also described later.

The nutrition can be any kind of nutrition which is eaten or drunken by the use of a feeding device. Preferably, the nutrition is a liquid nutrition, but the invention is not limited thereto.

The suction portion 3 comprises a suction and outlet opening 5, in the following also referred to as opening. By means of said opening 5, a user can suck the nutrition through the inlet 4 of the inlet portion 2 into the feeding device 1. The sucked nutrition can then be dispensed through said opening 5. In a preferred embodiment, the opening 5 in the suction portion 3 is a valve means being designed such that it only opens under suction. Thereby, a loss of nutrition and nutritional additive can be avoided when the feeding device is not in use, i.e. not sucked nor deformed.

The inner surface 6 confining said flow path P preferably extends from the inlet 4 to the opening 5.

In a further preferred embodiment of the invention, the feeding device 1 comprises at least a further opening (not shown). By means of said feature, the flow of air through said hole or opening can be enabled during suction when the feeding device is adapted to a non-flexible container, e.g. a glass container, or the like, but may also facilitate the suction action when using a flexible container or no container at all. Hence, said opening is used as an air inlet when the feeding device is sucked for attaining a pressure compensation.

At the inner surface 6, i.e. the flow path confining inner surface 6, of the feeding device 1 a nutritional additive 7 is adhered. Therefore, the nutritional additive 7 is purposely applied to said flow path confining inner surface 6. The nutritional additive 7 can be any kind of additive known by the person skilled in the art as, for instance, probiotics or the like. However, the invention is not limited to probiotics but also includes other additives like other active agents as, for example, prebiotics, LC-PUFA's and so on.

Probiotic micro-organisms are micro-organisms which beneficially affect a host by improving its intestinal microbial balance. According to the currently adopted definition by FAO/WHO, probiotics are: “Live microorganisms which when administered in adequate amounts confer a health benefit on the host”. In general, probiotic micro-organisms produce organic acids such as lactic acid and acetic acid which inhibit or influence the growth and/or metabolism of pathogenic bacteria such as Clostridium perfringens and Helicobacter pylori in the intestinal tract. Consequently, probiotic bacteria are believed to be useful in the treatment and prevention of conditions caused by pathogenic bacteria. Further, probiotic micro-organisms are believed to inhibit the growth and activity of putrefying bacteria and hence the production of toxic amine compounds. It is also believed that probiotic bacteria activate the immune function of the host.

Examples of suitable probiotic micro-organisms include yeasts such as Saccharomyces, Debaromyces, Candida, Pichia and Torulopsis, moulds such as Aspergillus, Rhizopus, Mucor, and Penicillium and Torulopsis and bacteria such as the genera Bifidobacterium, Bacteroides, Clostridium, Fusobacterium, Melissococcus, Propionibacterium, Streptococcus, Enterococcus, Lactococcus, Staphylococcus, Peptostrepococcus, Bacillus, Pediococcus, Micrococcus, Leuconostoc, Weissella, Aerococcus, Oenococcus and Lactobacillus. Specific examples of suitable probiotic micro-organisms are: Saccharomyces cereviseae, Bacillus coagulans, Bacillus licheniformis, Bacillus subtilis, Bifidobacterium bifidum, Bifidobacterium infantis, Bifidobacterium longum, Enterococcus faecium, Enterococcus faecalis, Lactobacillus acidophilus, Lactobacillus alimentarius, Lactobacillus casei subsp. casei, Lactobacillus casei Shirota, Lactobacillus curvatus, Lactobacillus delbruckii subsp. lactis, Lactobacil-2Q lus farciminus, Lactobacillus gasseri, Lactobacillus helveticus, Lactobacillus johnsonii, Lactobacillus reuteri, Lactobacillus rhamnosus (Lactobacillus GG), Lactobacillus sake, Lactococcus lactis, Micrococcus varians, Pediococcus acidilactici, Pediococcus pentosaceus, Pediococcus 25 acidilactici, Pediococcus halophilus, Streptococcus faecalis, Streptococcus thermophilus, Staphylococcus carnosus, and Staphylococcus xylosus.

The probiotic bacteria may be used live, inactivated or dead or even be present as fragments such as DNA or cell wall materials. In other words, the quantity of bacteria which the formula contains is expressed in terms of the equivalent colony forming units of bacteria irrespective of whether they are, all or partly, live, inactivated, dead or fragmented.

The probiotic bacterial strain may be any lactic acid bacteria or Bifidobacteria with established probiotic characteristics. The probiotic of the invention may be any probiotic bacteria or probiotic microorganism that have been or can be originated, found, extracted or isolated in milk upon excretion, preferably in human breast milk. Suitable probiotic lactic acid bacteria include Lactobacillus rhamnosus ATCC 53103 obtainable inter alia from Valio Oy of Finland under the trade mark LGG, Lactobacillus rhamnosus CGMCC 1.3724, Lactobacillus reuteri ATCC 55730 and Lactobacillus reuteri DSM 17938 obtainable from Biogaia, Lactobacillus fermentum VRI 003 and Lactobacillus paracasei CNCM I-2116, Lactobacillus johnsonii CNCM I-1225, Lactobacillus Helveticas CNCM I-4095, Bifidobacterium breve CNCM I-3865, Bifidobacterium longum CNCM I-2618.

Suitable probiotic Bifidobacteria strains include Bifidobacterium longum ATCC BAA-999 sold by Morinaga Milk Industry Co. Ltd. of Japan under the trade mark BB536, the strain of Bifidobacterium breve sold by Danisco under the trade mark Bb-03, the strain of Bifidobacterium breve sold by Morinaga under the trade mark M-16V and the strain of Bifidobacterium breve sold by Institut Rosell (Lallemand) under the trade mark R0070. A particularly preferred Bifidobacterium strain is Bifidobacterium lactis CNCM I-3446 which may be obtained from the Christian Hansen Company of Denmark under the trade mark Bb12. A mixture of suitable probiotic lactic acid bacteria and Bifidobacteria may be used.

As described above, the nutritional additive 7 is purposely adhered to the flow path confining inner surface 6 of the feeding device 1, preferably at least to the inner surface of the suction portion 3. As the nutritional additive 7 is thus also necessarily located in the flow path P, the nutritional additive 7 is located at a place which is influenced by the suction of the user and through which the nutrition passes. The suction of the user may lead to a deformation of the feeding device 1, at least the suction portion 3 of the feeding device 1. Hence, the nutritional additive, when being placed in said deformable portion of the feeding device, i.e. preferably the suction portion, is securely segregated from the feeding device since the segregation is promoted by the deformation caused by the suction which in any case occurs when being used. Due to a deformation, the nutritional additive 7 is thus separated or released from the inner surface 6 and falls off of said inner surface 6 into the nutrition which is sucked through the feeding device 1 into the user's mouth. Hence, a mechanically segregation of all nutritional additive 7 during a suction process can be securely accomplished. For enhancing the mechanical segregation, the feeding device 1 is at least partially deformable, preferably made of a flexible material, which can be a flexible polymeric material, preferably silicon. By using such a material, the feeding device can be easily and economically produced while at the same time leading to a sufficient flexibility or formability such that the matrix-and-nutritional-additive film can be easily broken due to mechanical segregation when the user sucks at the feeding device, thus promoting the removal of the nutritional additive during the suction action.

In addition, by the interaction of the adhered nutritional additive 7 with the nutrition passing through the flow path P of the feeding device 1, the nutritional additive 7 is also mechanically segregated by the flowing nutrition, which is thus swept along with the nutrition to the outlet opening 5 and into the user's mouth. The nutrition preferably is a liquid or viscous nutrition such that a sufficiently high amount of a liquid can be provided to wash-out and dilute the deposit of the nutritional additive 7, particularly in comparison to a dry pacifier.

In a preferred embodiment, the nutritional additive is adhered to the feeding device 1 such that it can be quickly diluted, flushed out or segregated at the beginning of the suction even if the nutrition, e.g. placed in a bottle or the like, is not fully finished. Hence, a controlled dosage applied to the user can be achieved.

Hence, the supply of the nutritional additive 7, particularly the amount of which, is not dependent on the suction power of the user only, since there is a fine balance between the adhesion of the nutritional additive 7 to the inner surface 6 of the feeding device 1 and the ability to be released upon mechanical movement by sucking, the interaction with the nutrition and/or the temperature, for example. It also has to be noted that some nutritional additives may adhere more easily to the surface of the feeding device than others due to a difference in its cell surface or secretions. The nutritional additive 7 thus completely falls off of the wall (inner surface 6) and is swept along when the feeding device 1 is sucked and thus deformed, and nutrition is therefore delivered through the feeding device 1 to the user's mouth or the like. The dosage of the nutritional additive 7 can be clearly determined, e.g. to a controlled monodose, thus allowing to precisely insure a safe and efficient dosage of the nutritional additive 7 in comparison with a bulk delivery of additives.

To enhance the mechanical segregation, the nutritional additive 7 is preferably adhered to a portion at the flow path confining inner surface 6 of the feeding device 1, where a lot of the nutrition passes by and/or where the flow velocity of the nutrition is comparatively high. In this regard, the solid line in FIG. 1 refers to a preferred positioning of the nutritional additive 7. In this preferred embodiment, the nutritional additive 7 is at least adhered to the inner surface 6 of the suction portion 3, in a more preferred embodiment at least close to the outlet opening 5 of the suction portion 3. In this preferred and more preferred positioning of the nutritional additive 7 at the flow path confining inner surface 6 of the feeding device 1, the occurrence of a lot of nutrition is assured and its flow velocity is comparatively high due to the tapering of the feeding device 1.

The dashed line in FIG. 1 refers to another possible positioning of the nutritional additive 7. However, the invention is not limited to the before-mentioned positioning of the nutritional additive 7. The nutritional additive 7 can be applied to any position on the flow path confining inner surface 6 of the feeding device 1 as long as a mechanical segregation as described above can be achieved. As the inner surface 6 confines the flow path P of the feeding device 1, there is generally no limitation to a specific positioning of the nutritional additive 7 on the inner surface 6.

The adhesion of the nutritional additive 7 to the inner surface 6 of the feeding device 1 can be accomplished in a plurality of ways, which are described in the following.

The inner surface 6 of the feeding device 1 can be treated to enable adhesion of the nutritional additive 7. Thereby, the nutritional additive 7 can be easier adhered to the inner surface. The surface treatment can be done by roughening the surface, for instance. However, any possibility known by the person skilled in the art for making a surface more adhesive-friendly is covered by the invention, which is thus not limited to the before-mentioned examples.

Additionally, the nutritional additive 7 can also be mixed with a substance 8 having a good stickiness for promoting the adhesion of the mix to the inner surface 6 of the feeding device 1 and/or enhancing its stability. Such a substance 8 can be a matrix, preferably an oil (e.g. containing MCT), an emulsion or a gel. Any other known substances which are usually known by the person skilled in the art for such intended uses are also covered by the invention.

The substance 8, e.g. an oil or wax matrix, preferably crystallizes at a temperature above room temperature (e.g. 40 degrees Celsius). Hence, the substance 8 is solid at room temperature. For easily applying the nutritional additive 7 to the inner surface 6 of the feeding device 1, the nutritional additive 7 is mixed with said substance 8 or matrix being in a fluid condition. Then, the matrix-and-nutritional-additive mixture can be easily applied to the inner surface 6 by spray coating or the like to attain a film cover which, after being applied to said inner surface 6, cools down and gets solid, thus immobilizing the nutritional additive 7 in the matrix. The nutritional additive 7 can thus be securely adhered to the inner surface 6 of the feeding device 1. Even if the before-mentioned way of applying the matrix-and-nutritional-additive mixture onto the inner surface 6 of the feeding device 1 is preferred, the invention is not limited to thereto. Other ways of applying said mixture known by the person skilled in the art are also covered by the invention.

A further possibility can, for instance, be the placement of the nutritional additive 7 in the tip, i.e. the suction portion 3, preferably close to the opening 5 of the feeding device 1 via a sedimentation process. Therefore, the feeding device is mounted on a liquid reservoir comprising a non-homogeneous solution that preferably consists of the nutritional additive in a liquid or viscous carrier. In a preferred embodiment, the feeding device 1 is filled with said solution itself. Thereby, the volume of the liquid reservoir or the feeding device 1 may not be completely filled with the non-homogeneous solution, thus gas may as well be present within the liquid reservoir.

In case the nutritional additive has a lower specific weight than the carrier, the concentration of the nutritional additive 7 may decreases from a top portion (on which the feeding device is mounted) towards a bottom portion of the reservoir. Thereby, the concentration of the nutritional additive in a portion close to the opening 5 of the feeding device 1 is preferably 3 to 10 times the concentration of the nutritional additive 7 contained in its bottom portion.

In a preferred embodiment, the high concentration of the nutritional additive 7 forms an aggregated portion of nutritional additive particles, which is preferably designed to plug the outlet 5 of the feeding device 1. Accordingly, a plug of nutritional additive 7 is formed at the outlet 5, which contains the largest portion of the nutritional additive 7 present within the reservoir or feeding device 1. Hence, when applying the feeding device 1 to a container comprising a nutrition or just leaving the feeding device 1 being mounted on said reservoir, during dispensing of the ingredients from the container or reservoir, the plug can be first expelled from the feeding device 1 and thus, it can be ensured that the withholding of nutritional additive 7 within the feeding device 1 during the dispensing process is minimized. Accordingly, a very accurate dose of nutritional additive 7 can be administered to a user or to a mixing vessel that contains a portion of infant formula.

According to another aspect of the invention, due to the sedimentation of the nutritional additive 7 within the feeding device 1 or reservoir which have a higher specific weight than the viscous or liquid carrier, a higher concentration of nutritional additive particles is present at the bottom portion (of the liquid reservoir or feeding device 1) compared to a top portion (of the liquid reservoir or feeding device 1). More particularly, the concentration of the nutritional additive 7 in this state decreases from the bottom portion towards the opening 5 arranged opposite to the bottom portion of the reservoir or feeding device 1.

After filling of the feeding device 1 or reservoir onto which the feeding device 1 is mounted with the ingredients, an externally provided sealing means can be provided which are designed to close-off the outlet 5 of the feeding device 1. The sealing means may be a part of a centrifugation device preferably used to enable a specific sedimentation of the nutritional additive 7 within the feeding device 1, preferably the suction portion 3 close to the outlet 5. However, the sealing means may as well be a part of an external packaging in which the container 1 is to be intermediately stored for a predefined time to enable a sedimentation of the nutritional additive 7.

After the provision of the external sealing means, a specific sedimentation of the nutritional additive 7 is carried out. Thereby, the sedimentation is specifically carried out to make the nutritional additive 7 sediment at the outlet 5. The sedimentation of the nutritional additive 7 is preferably obtained by centrifugation of the feeding device 1 or reservoir being connected to the feeding device 1, at least for a predefined time period of about 30 to 120 seconds at a speed between 700 to 3500 RPM.

Due to the higher specific weight of the nutritional additive 7 within the liquid or viscous carrier, the nutritional additive 7 will form a sedimentation cake at the outlet 5 of the feeding device 1. Accordingly, a solid nutritional additive plug 7 is formed at the outlet 5.

In a preferred embodiment, due to a predefined sedimentation volume resulted in the volume of the reservoir or feeding device 1 not being completely filled and in a case a bottle containing a nutrition is applied to the feeding device, when being in a normal storage position in which the feeding device 1 is stored with its inlet 4 of the inlet portion 2 facing downwards, the viscous or liquid carrier is prevented from reaching to the nutritional additive plug as an optional clearance distance is preferably present between the liquid within the container and the solid nutritional additive plug.

In any case, due to the sedimentation process of the nutritional additive 7, a very solid plug is preferably arranged at the outlet 5 of the feeding device 1 which prevents any leaking of the feeding device 1 irrespective of the container's orientation.

After the sedimentation process, the external sealing means can be taken from the outlet 5 of the feeding device 1, as the outlet 5 is now closed by the solid nutritional additive plug.

An alternative of sedimentation by means of centrifugation is an intermediate storage of the feeding device 1 with applied external sealing means, whereby the container is stored with the outlet 5 at a lower position relative to the bottom portion (i.e. inlet portion 2) of the feeding device 1 or of the reservoir.

Moreover, the feeding device 1 may as well be arranged in an additional packaging in which the sedimentation is carried out during storage of the container within the packaging before the dispensing process. Therefore, the packaging preferably comprises means for supporting the externally provided sealing means. However, the sealing means may as well be integrally formed with the packaging. Moreover, the packaging preferably comprises a support structure for supporting the feeding device 1 within the packaging in a correct orientation. Thereby, the support structure is preferably arranged to support the feeding device 1 in a position in which the outlet 5 is arranged at a lower position relative to the inlet portion 2 or liquid reservoir. Hence, due to the sedimentation of the solid nutritional additive particles within the feeding device 1 which are preferably guided to the outlet 5, a sedimentation cake or plug is formed at the outlet 5 during storage of the feeding device 1 within the packaging. The packaging preferably comprises orientation means which enable the user to store the packaging in the correct orientation. For example, the packaging may be of a particular shape to guide a user to apply a correct storage position of the packaging. For example, the packaging may be of triangular of conical shape. In addition, the packaging preferably comprises a printed label on its outer surface indicating a correct storage position to a user.

Again referring to FIG. 1. by suction of the user, the shape of the feeding device 1 is modified, i.e. deformed, and due to this, the matrix-and-nutritional-additive film breaks and falls off the flow path confining inner surface 6 and subsequently falls into the nutrition passing through the flow path P in the feeding device 1. It is also possible that in case the nutritional additive 7 is applied as a plug via sedimentation, the plug is released due to the suction and deformation action. In case, a warm nutrition (having a temperature above the crystallizing temperature of the matrix) is fed, the matrix liquefies again by means of the passing warm/hot nutrition and can thus be easily displaced by the nutrition due to temperature and mechanical segregation. In addition or alternative to the temperature, the release-ability of the matrix from the inner surface 6 of the feeding device 1 can also be attained or enhanced by the pH and/or the salinity of the nutrition or other factors commonly known by the person skilled in the art. In other words, the segregation of the nutritional additive can be enhanced by either a dissolution of the additive and/or of the protective matrix (e.g. oil matrix or wax matrix), or a specific interaction in particular conditions such as pH of the nutritional composition enhancing segregation by acting on the protective matrix, or mechanical shaking of a container or bottle containing said nutrition and onto which the feeding device is mounted, or a combination thereof.

Hence, the deposition properties of the nutritional additive 7 can be easily determined and adjusted by varying the balance between immobilization of the nutritional additive 7 in the substance 8, the stickiness of said substance 8 or matrix to the walls (i.e. inner surface 6) of the feeding device 1, and the ability of the substance 8 or matrix to be displaced by the nutrition and/or by the mechanical effect of the sucking.

FIG. 2 shows a second embodiment of a feeding device 1′ according to the present invention. The feeding device 1′ also comprises an inlet portion 2′ with an inlet 4′ and a suction portion 3′ with an opening 5′ as well as a nutritional additive 7′ (preferably being mixed with a substance 8′) adhered to the inner surface 6′ confining a flow path P′ of the feeding device 1′. The respective features of this embodiment have the same function and properties as the features mentioned in the first embodiment. Everything which has been said about the first embodiment thus also applies for the second embodiment.

In addition to the feeding device 1 according to the first embodiment, the feeding device 1′ of FIG. 2 has a more anatomical shape. This anatomical shape has at least two diameters, wherein the inlet portion 2′ has a bigger diameter than the suction portion 3′. The small diameter of the suction portion 3′ enables the lips of a user to grab the suction portion 3′ or nipple or teat, and the larger diameter of the inlet portion 2′ preferably fits a diameter of a container (e.g. a bottle). The transition portion T′ from the small diameter to the larger diameter can act as a stopper for the user's mouth.

The shown feeding device 1′ also has an outwardly extending flange portion 9′ at its lower end/bottom portion close to the inlet 4′ of the inlet portion 2′. Said flange portion 8′ can serve as a support when mounting the feeding device 1′ to a container as will be described with reference to FIG. 3 below.

The feeding device 1′ thus has a commonly known shape of a nipple for a baby bottle. The invention, however, is not limited to this design or number of diameters or its dimensions, as long as a user can suck nutrition by means of the feeding device.

As can be seen in FIG. 2, the nutritional additive 7′ is preferably located at regions (solid lines) inside the feeding device 1 and at its inner surface 6′, i.e. in the flow path P′, where nutrition surely passes by and/or its flow velocity is high. The nutritional additive 7′, however, can be applied to any other region (e.g. dashed line) on the flow path confining inner surface 6′ of the feeding device 1′, as long as mechanical segregation by the sucking action and/or the interaction with the nutrition appears. The nutritional additive 7′ can thus also be applied to the feeding device 1′ as a plug via sedimentation as explained above.

Additionally, FIG. 3 shows a feeding apparatus 10 according to the invention comprising a container 11, and a feeding device 1″. The container 11 comprises an outlet 12 for dispensing the nutrition 13 being stored inside the container 11. Everything which has been said in respect with the feeding devices 1, 1′ according to the first and second embodiments also applies for the feeding device 1″ shown in FIG. 3 having the same features with corresponding references.

The feeding device 1″ is mounted on the container 11 with its inlet portion (see inlet portion 2′ in FIG. 2, for instance) such that nutrition 13 being stored in the container 11 can exit the container 11 through its outlet 12 and enter the feeding device 1″ through its inlet (see inlet 4′ in FIG. 2, for instance) when in use. Hence, a flow of the nutrition out of the container 11 into the feeding device 1″ and through said feeding device 1″ via the flow path P″ (confined by the inner surface 6″) and then out of the feeding device 1″ via the opening 5″ is provided, such that the feeding device 1″ can be used in a commonly known apparatus as, for example, a baby bottle which can also be used for feeding animals or the like.

In the preferred embodiment shown in FIG. 3, the feeding apparatus 10 preferably comprises a fixing means 14 for removably linking the feeding device 1″ to the container 11. The fixing means 14 can be an adaptation ring with a closure mechanism or a screw thread such that the feeding device 1″ can be easily applied to and removed from the container 11.

Preferably, the feeding device 1″ can be placed on the outlet 12 of the container 11 with its flange portion (cf. FIG. 2: 8′), which then is pinched or clamped between the container 11, i.e. the outlet of said container 11, and the fixing means 14 in a commonly known way, which is thus not further explained. In a preferred embodiment, the fixing means 14 is an adaptation ring with a closure mechanism or a screw thread. However, the feeding device 1″ can be mounted to the container 11 in any known way as long as a nutrition 13 flow from the container 11 into the feeding device 1″ is guaranteed and the connection is preferably sealed such that no nutrition 13 can leak. The feeding device 1, 1′, 1″ can also be imposed on the outlet 12 of the container 11 without the use of any fixing means. If necessary, the imposed feeding device 1, 1′, 1″ can also be fixed with the aid of a rubber band or clip or any other fixing means known by the person skilled in the art.

The feeding apparatus 10 can also be used as the reservoir (11) being provided with the feeding device (1, 1′, 1″) for the before-mentioned sedimentation processes.

In the following, a method for mixing nutrition and a nutritional additive in the feeding device 1, 1′, 1″ will be described.

The feeding device 1, 1′, 1″ can be mounted, e.g. via a fixing means 14, on a container 11 comprising a nutrition 13, or can be used as a straw or the like for sucking a nutrition 13, e.g. stored in a receptacle or the like. Then, the user sucks at the suction portion 3, 3′, 3″ of the feeding device 1, 1′, 1″. Due to the sucking action through the opening 5, 5′, 5″ in the suction portion 3, 3′, 3″, preferably low-pressure occurs in the feeding device 1, 1′, 1″ thus nutrition 13 is sucked out of the container 11 or other receptacle or the like through the inlet 4, 4′ of (or in) the inlet portion 2, 2′, 2″ into the feeding device 1, 1′, 1″. Then, the nutrition 13 passes or flows through the feeding device 1, 1′, 1″, i.e. the nutrition 13 flows through the flow path P, P′, P″ confined by the inner surface 6, 6′, 6″ of the feeding device 1, 1′, 1″, towards the suction portion 3, 3′, 3″. The nutritional additive 7, 7′, 7″ is adhered to the flow path confining inner surface 6, 6′, 6″ of the feeding device 1, 1′, 1″ as described above, preferably supported by a substance 8, 8′, 8″ for promoting the adhesion of the substance-and-nutritional-additive mixture to the inner surface 6, 6′, 6″ and/or enhancing its stability. The nutritional additive 7, 7′, 7″ adhered to said inner surface 6, 6′, 6″, i.e. in the flow path P, P′, P″, is then mechanically segregated, at least due to the mechanical effect of the sucking, the deformation of the feeding device 1, 1′, 1″ and/or the interaction of the flowing nutrition 13 with the nutritional additive 7, 7′, 7″ when the nutrition 13 passes through the feeding device 1, 1′, 1″. Then, the nutrition 13 and the nutritional additive 7, 7′, 7″ are blended and dispense out of the opening 5, 5′, 5″ in the suction portion 3, 3′, 3″ of the feeding device 1, 1′, 1″.

In a preferred embodiment, the feeding devices 1, 1′, 1″, supposedly provided with the nutritional additive 7, 7′, 7″ by the manufacturer/producer, are individually packed in a material promoting the preservation and stability of the nutritional additive 7, 7′, 7″. Such a material can be, for instance, a polymeric or aluminum air-tight foil. Preferably, the feeding device 1, 1′, 1″ is packed in an aluminum blister and gassed. Thereby, a germ-free environment can be achieved to obtain the high purity and sanitization standards for such devices. However, the invention is not limited to the before-mentioned kinds of packaging.

In one embodiment the nutritional additive 7, 7′, 7″ is in the form of a powder, a liquid, a viscous liquid or semi-liquid, a dry extract or a dry matter.

In one embodiment, especially when the nutritional additive 7, 7′, 7″ is in the form of a powder, a dry extract a dry matter or the like, the feeding device 1, 1′, 1″ and/or the dry matter, dry extract or powder is treated such as to promote the adhesion of the dry matter, dry extract or powder to the surface of the feeding devicel, 1′, 1″. Such treatment can encompass treating said entities such as to promote the electrostatical adhesion of said dry powder, dry matter or dry extract to said surface. The surface of the feeding device 1, 1′, 1″ can be treated, and/or the dry powder/matter/extract can also be treated.

For example the nutritional additive 7, 7′, 7″ in the form of dry powder particles can be made positively or negatively charged, and can be deposited (by spraying for example) on the inner surface of the feeding device 6, 6′, 6″. Thereby, the charged particles will adhere on the surface of the feeding device 1. The material of the feeding device 1, 1′, 1″ can be selected such as to promote such adhesion. It has been found that a flexible polymeric material such as latex or silicon can be best suited. Such electrostatic treatment can be performed by an electrostatical treatment known in the art.

In one embodiment said treatment for promoting the adhesion can comprise adhering the nutritional additive 7, 7′, 7″ in a wet form (for example having a dry content of more than 50%, 70%, 80%, 90%, 95%, or 99%, but less than 100%). The presence of water can promote the adhesion. Said treatment can encompass removing said water to further promote the adhesion.

In one embodiment the dry powder, dry matter or dry extract is accompanied and/or mixed with a substance 8, 8′, 8″ and/or matrix promoting such adhesion. Said substance can be a sugar (for example maltodextrin, fructose, sucrose, or glucose) or an oil.

In one embodiment the nutritional additive 7, 7′, 7″ comprises probiotics and can comprise or be mixed with maltodextrin. In one embodiment the above nutritional additive 7, 7′, 7″ is applied to the inner surface of the feeding device 6, 6′, 6″ by spraying. In one embodiment the remaining water is removed by evaporation of the water (for example by increasing the temperature). In one embodiment the inner surface of the feeding device 6, 6′, 6″ is physically rough (i.e. presenting asperities) such as to promote such adhesion.

Additionally, the feeding device 1, 1′, 1″ coated with the nutritional additive 7, 7′, 7″ can be packed into a container (bag, carton box, plastic box) favoring the electrostatic interaction (hence the adhesion). Such a container will contain desiccating agents, thereby ensuring a dry atmosphere around the device and hence promoting the adhesion and/or the stability of the adhesion. Desiccant can be of any type by a skilled person in the field, and which shows both good hygroscopic properties combined with food safety. In one embodiment the container is dimentionallized to contain about between 10 and 200 feeding devices 1, 1′, 1″, preferably between 20 and 60. In one embodiment the container comprises a flexible film, preferably a multilayer film and said film comprises the desiccant.

Although the present invention has been described with reference to preferred embodiments thereof, many modifications and alternations may be made by a person having ordinary skill in the art without departing from the scope of this invention which is defined by the appended claims. For example, the use of the feeding device is not limited to a baby bottle, but can be used as a feeding device in any kind of feeding apparatus known in state of the art as, for instance, an apparatus for suckling animals or the like, or it can be used solely, e.g. as a straw. Moreover, the regions to which the nutritional additive is applied to the flow path confining inner surface of the feeding device is not limited by the invention. The shape and material of the feeding device is also not limited as long as being covered by the subject-matter of the appended claims and the intended use.

### REFERENCE NUMERALS

1, 1′, 1″ feeding device
2, 2′, 2″ inlet portion
3, 3′, 3″ suction portion
4, 4′ inlet of (or in) the inlet portion (inlet)
5, 5′, 5″ suction and outlet opening (opening)
6, 6′, 6″ (flow path confining) inner surface of the feeding device
7, 7′, 7″ nutritional additive
8, 8′, 8″ substance (matrix)
9′ flange portion
10 feeding apparatus
11 container
12 outlet (outlet opening)
13 nutrition
14 fixing means
T′ transition portion
P, P′, P″ flow path

1. A feeding device having a hollow form, the feeding device comprising:
an inlet portion having an inlet for receiving nutrition;
a suction portion for sucking the nutrition through the inlet into the feeding device, wherein the suction portion comprises at least one opening for dispensing the sucked nutrition;
the inner surface of the feeding device defines a flow path for the nutrition;
the feeding device is at least partially deformable; and
a nutritional additive is adhered to the flow path confining inner surface of the feeding device such that the nutritional additive is mechanically segregated from the inner surface when the feeding device is deformed.

2. The feeding device according to claim 1,
wherein the nutrition is a liquid or viscous nutrition.

3. The feeding device according to claim 1,
wherein the inner surface of the feeding device is treated to enable adhesion of the nutritional additive.

4. The feeding device according to claim 1,
wherein the nutritional additive is mixed with a substance for promoting the adhesion of the mix to the inner surface of the feeding device and/or enhancing its stability.

5. The feeding device according to claim 4,
wherein the substance is a matrix.

6. The feeding device according to claim 1,
wherein the nutritional additive is at least adhered to the inner surface of the suction portion.

7. The feeding device according to claim 1,
wherein at least the suction portion of the feeding device is deformable.

8. The feeding device according to claim 1,
wherein the opening in the suction portion is a valve designed such that it only opens under suction.

9. The feeding device according to claim 1,
wherein the feeding device comprises at least a further opening as an air inlet when the feeding device is sucked.

10. The feeding device according to claim 1,
wherein the feeding device has an anatomical shape.

11. The feeding device according to claim 1,
wherein the feeding device is made of a flexible material.

12. A feeding apparatus comprising:
a container having an outlet, and
a feeding device having a hollow form, the feeding device comprising an inlet portion having an inlet for receiving nutrition, a suction portion for sucking the nutrition through the inlet into the feeding device, wherein the suction portion comprises at least one opening for dispensing the sucked nutrition, the inner surface of the feeding device confines a flow path for the nutrition, the feeding device is at least partially deformable, and a nutritional additive is adhered to the flow path confining inner surface of the feeding device such that the nutritional additive is mechanically segregated from the inner surface when the feeding device is deformed; and
the feeding device being mounted on the outlet of the container with its inlet portion.

13. The feeding apparatus according to claim 12,
wherein the feeding apparatus comprises a fixing member for removably linking the feeding device to the container.

14. The feeding apparatus according to claim 13,
wherein the fixing member is a ring with a closure mechanism or a screw thread.

15. The feeding apparatus according to claim 1,
wherein the nutritional additive comprises probiotics.

16. A method for mixing a nutrition and a nutritional additive in an at least partially deformable feeding device comprising:
sucking at a suction portion of the feeding device, wherein the nutrition is sucked through an inlet of an inlet portion into the feeding device;
passing the nutrition through a flow path defined by the inner surface of the feeding device, towards the suction portion;
mechanically segregating the nutritional additive so that it is adhered to the flow path defining inner surface of the feeding device by deformation of the feeding device,
blending of the nutrition and the nutritional additive; and
dispensing of the nutrition with the nutritional additive out of at least one opening in the suction portion of the feeding device.

17. A method for enclosing a non-homogeneous solution of a nutritional additive in a viscous or liquid carrier within a feeding device having a hollow form, the feeding device comprising an inlet portion having an inlet for receiving nutrition, a suction portion for sucking the nutrition through the inlet into the feeding device, wherein the suction portion comprises at least one opening for dispensing the sucked nutrition, the inner surface of the feeding device confines a flow path for the nutrition, the feeding device is at least partially deformable, and a nutritional additive is adhered to the flow path confining inner surface of the feeding device such that the nutritional additive is mechanically segregated from the inner surface when the feeding device is deformed comprising the steps of:
filling the non-homogeneous solution in a reservoir of the feeding device;
closing the outlet by using a sealer; and
plugging the outlet by specifically sedimenting the nutritional additive opposite to an inlet portion of the feeding device.

18. The method according to claim 17,
wherein plugging of the outlet is achieved by a centrifugation of the feeding device.

19. The method according to claim 17,
wherein plugging of the outlet is achieved by arranging the feeding device with the outlet facing downwards in an external support packaging having the sealer designed to seal the outlet during the sedimentation process.

20. The method according to claim 16,
wherein the dispensing container provided with the feeding device forms a feeding apparatus.

21. The method according to claim 16, wherein the nutritional additive comprises probiotics.
